(19) United States
(12) Patent Application Publication
(10) Pub. No.: US 2014/0330913 A1
(43) Pub. Date: Nov. 6, 2014

(54) EMAIL CONVERSATION MANAGEMENT SYSTEM

(71) Applicant: DORON PASCAL, MOSHAV GIVAT YEARIM (IL)

(72) Inventor: DORON PASCAL, MOSHAV GIVAT YEARIM (IL)

(21) Appl. No.: 14/269,330

(22) Filed: May 5, 2014

Related U.S. Application Data
(60) Provisional application No. 61/819,685, filed on May 6, 2013.

(51) Int. Cl. H04L 12/58

(52) U.S. Cl. CPC H04L 51/02; H04L 51/16
USPC 709/206

(57) ABSTRACT

Systems and methods of the present disclosure relate to email communication, and more specifically relate to communication between heterogeneous and/or homogeneous email clients through metadata or other type/mode of data to automatically update respective email applications with one or more changes/features that increase the efficiency of communication and enhance user's readability/experience of working with respective email applications.

### CROSS-REFERENCE TO RELATED APPLICATIONS

This application claims the benefit of priority of U.S. Patent Application No. 61/819,685, filed on May 6, 2013, the disclosure of which is are incorporated herein by reference in its entirety. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is email communication.

### BACKGROUND

The background description includes information that may be useful in understanding the present invention. It is not an admission that any of the information provided herein is prior art or relevant to the presently claimed invention, or that any publication specifically or implicitly referenced is prior art.

Every day, people send and receive millions of emails (also written as “e-mail” or “Electronic Mails”) messages over computer networks for business and leisure. Email, being convenient, easy to use and close to instantaneous in many cases, has become an extremely popular communication channel for people to exchange information.

Even though numerous technological changes have taken place in the last decade on improving/enhancing network attributes, network technologies, security features, architectural issues, communication performance, among other aspects, few changes have actually taken place in the email communication interfaces, which largely continue to be the same for the last many years. Email communication interfaces are typically configured as email clients, also referred to as email applications, such as Microsoft Outlook™, Google Mail (Gmail™), Lotus Notes™, among other like email clients. User interface of most of these interfaces is largely the same with each email being represented by a subject, sender name/details, recipient name/details, time of mail, among other like attributes. Such email clients expect users to open each mail to determine whether the email message is relevant or not, or whether the email is to dealt with right now or not, or what the priority of the email is, among other like issues. All email clients, although operatively coupled with each other through a network such as Internet, work basically as standalone applications and rely completely on their respective users to perform one or more actions such as read email, delete email, mark email as spam, reply to email, among other like actions. Such emails are not automatically representative of their priority, preference, or how other users/recipients/colleagues feel about the email.

Another drawback to existing email systems is that managing emails, new incoming and new outgoing, and their subsequent replies and forwards, is increasingly difficult with the growing volumes of emails, and more often than not leads to cluttered inbox, sent, and deleted folders. The inbox folder often becomes cluttered because emails, new incoming emails as well as previously read emails, are stored in the inbox folder until a user manually moves the emails out of it. Emails get cluttered in the sent folder because new emails sent out by the user are stored in the sent folder, and replies and forwards sent by the user to others are also stored in the sent folder.

Over time, the clutter keeps increasing, and it is quite common for users to have hundreds of emails sitting in the inbox, sent mail, and other named folders. It takes considerable effort to move and keep moving the emails into other named folders, to keep the clutter from growing. As the emails are moved into named folders, the named folders themselves get cluttered with repetitive emails. The user is afraid to delete any email (in inbox, sent or named folders) for fear of losing something important, and because of time constraints is unlikely to sift through these emails in order to reduce their redundancy.

It also common to have an email thread being created by means of multiple replies to one email chain, wherein, for instance, to a first email, a first reply can be made, and then another second reply can be made to the first reply and/or directly to the first email, and likewise, a third reply can be made. On-line threaded discussions or conversations (e.g., in electronic mail, news groups, Internet chats, discussion databases, etc.) have gained increasing popularity. In general, threaded conversations allow multiple parties to communicate about and collaborate around any number of topics. A threaded conversation typically comprises numerous discussion streams or branches of messages. Branches are usually created by replying to an existing message. Typically, threaded conversations are visualized in a hierarchical manner. To this extent, existing solutions to navigate about a threaded conversation use indentation of messages to display the hierarchical structure. As such email threads typically have a number of emails, keeping track of them or identifying one or more specific emails based on their content/recipients is difficult, and therefore no mechanism currently exists to simplify representation of email threads to one or more users of email clients.

There is therefore a need for systems and methods for improving email communications by means of intelligent email clients that communicate with each other without the need of user intervention, and also include features that facilitate easier identification/management of relevant emails, thereby enhancing overall email communication experience.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

Systems and methods of the present disclosure relate to email communication, and more specifically relate to communication between heterogeneous and/or homogeneous email clients through metadata or other type/mode of data to automatically update respective email applications/clients with one or more changes/features that increase the efficiency of communication and enhance user's readability/experience of working with respective email applications.

In an aspect of the present disclosure, an email client system can be operatively coupled, through say a network, with one or more other email client systems, interchangeably also referred to as email systems, or client systems, or email applications hereinafter. In an embodiment, a first email client system operated by a user can be coupled with a second email client system that is operated by a moderator (also referred to as mediator or administrator) such that one or more actions performed by the moderator on an email interchanged between the first email client system and the second email client system can be automatically implemented on the first email client system. Such actions can include, but are not limited to, highlighting the exchanged email, deleting the email, recommending the email, liking the email, blocking the email, or taking any other action on the email. For instance, a moderator, through its second email client system, can highlight an email received from the user for first email client system, wherein such highlight operation can be reflected as a counter on the first email client system interface of the user. In an exemplary implementation, moderator can, through a second email client or without the same, can also impact the display/presentation of emails (such as their color, order of presentation, font, size, shape, content) based on privileges accorded to the moderator. According to one embodiment, such an action can be taken by any other user of a third email client system as well, wherein, for instance, an email communication between the user of first email client system and user of the third email client system can be liked by the user of the third email client system such that “like” action is reflected on the corresponding email presented on the first email client system of the user.

In another aspect of the present disclosure, email client system can be configured to represent an email thread having at least one email in the form of a hierarchical tree presentation, wherein the hierarchical tree presentation comprises representation of each email of the email thread as a node, and wherein each node is connected to another node through an edge. Such a hierarchical tree presentation of email thread can include one or more branches that represent the sequence of responses to one or more emails of the email thread. For instance, in case a user A sends an email X to user B and C, and user B then responds back to A and C with email X′, one branch of an email thread can relate to emails replied to email X′ and another branch of an email thread can relate to emails replied to email X. In an implementation, each node of the hierarchical tree presentation can be represented through a color depending on whether that particular email of the email thread is liked, or is the currently opened email, or is highlighted, or is blocked, or is offlined, or is the first email in the email thread, or any other parameter/attribute defined for coloring a node of the email thread. Similarly, even the edges connecting multiple nodes can also be represented in colors or in any other desired representation such as through a bold line, regular line, dotted line, among other like representations. A user can then by clicking on any particular node on the thread schema, open the corresponding email and take action on the same. One should appreciate any all such representations are a matter of design, any such color/design/mode of representation is completely within the scope of the instant disclosure.

In yet another aspect of the present disclosure, email client system can be enabled to send metadata information directly to a second email client system without intervention of users of the email client system and the second email client system. Such metadata information can include, but is not limited to, information extracted from one or more user actions taken on emails of the email client system, information of emails liked by the user of the email client system, information of emails highlighted by the user of the email client system, information of priority of emails of the email client system, information of actions taken by moderator of a third email client system on the email client system, information of emails blocked by the user of the email client system, information of emails offlined by the user of the email client system, information of emails replied to by the user of the email client system, or any other action taken by the user of the email client system. Based on such metadata information received from the email client system, second email client system can automatically update its emails and/or configuration/settings thereof through actions including, but not limited to, deletion of one or more emails, prioritization of one or more emails, tagging of one or more emails, marking of one or more emails, liking of one or more emails, highlighting of one or more emails, blocking of one or more emails, offlining of one or more emails, or any other action taken automatically on the second email client system.

Still other embodiments include an email client system, for enabling email communications, implementable on a computing device comprising: one or more processors; and memory storing one or more programs to be executed by the one or more processors; the one or more programs comprising instructions for: marking at least one email as offline, wherein the at least one offline marked email is not shown in inbox of the email client system. Variously, the at least one offline marked email may be transferred to a separate email folder. Optionally, one or more emails of senders of the at least one offline marked email are automatically offlined. Where appropriate, the at least one offline marked email is an email from an email thread. In case the at least one offline marked email is part of at least one more email client systems than the email client system, the at least one more email client systems may also offline the email. Optionally, no incoming notification may be presented to user to the email client system for any reply to the offlined email.

In yet another embodiment an email client system is disclosed for enabling email communications, implementable on a computing device comprising: one or more processors; and memory storing one or more programs to be executed by the one or more processors; the one or more programs comprising instructions for: marking at least one email as blocked, wherein the at least one blocked email enables one or more of disallowing user of the email client system from replying to the blocked email, disallowing recipients of the blocked email from replying to the blocked email, representing the blocked email as a disabled email, and possibly transferring the blocked email to a blocked email folder.

In other embodiments, an email client system is disclosed for enabling email communications, implementable on a computing device comprising: one or more processors; and memory storing one or more programs to be executed by the one or more processors; the one or more programs comprising instructions for: tagging at least one existing sent/received email with a footnote, wherein the footnote is automatically tagged to at least one recipient of the email. Optionally, the email is tagged with the footnote by any recipient of the email. Where appropriate the footnote is visible to one or more recipients. Optionally, the footnote is visible only to users/email clients that are tagged with the footnote, and wherein the tagging is performed by user of the email client system.

According to another embodiment, an email client system is disclosed for enabling email communications, implementable on a computing device comprising: one or more processors; and memory storing one or more programs to be executed by the one or more processors; the one or more programs comprising instructions for: enabling the email client system to highlight at least one email, wherein the highlighting of the email on the email client system increases highlight counter of a sender of the email who is working on a second email client system. Optionally, the highlighting of the email is only done by a moderator having defined rights and privileges, wherein the moderator operates the email client system. Where appropriate, the highlighted email is represented in a different manner in one or more of the second email client system, and email client systems of recipients of the email. Optionally, the counter is associated with the sender and represents number of times emails of the sender working on second email client system are highlighted. Optionally, again, the highlighting action is reversible, and wherein un-highlighting the email decreased the highlight counter for the sender. Where appropriate, the email client system selects a special interest group having a defined number of desired recipients such that the highlighted email is specially marked only to the defined number of desired recipients in addition to being highlighted to all. Optionally, the highlighted email is represented in a defined manner in the email client's mail item inbox.

Other embodiments include an email client system, for enabling email communications, implementable on a computing device comprising: one or more processors; and memory storing one or more programs to be executed by the one or more processors; the one or more programs comprising instructions for: enabling the email client system to like at least one email by the user, wherein the liking of the email enables each recipient email client system of the email to see the liked representation. Optionally, the liking of the email is done by a plurality of users of different email client systems, wherein the system comprises a counter of the likes granted by the different email client systems to the user, wherein the counter increases with each like of the email. Where appropriate, the counter presents number of times the email has been liked, and further presents users involved in liking the email. Alternatively or additionally, the liked email may be disliked by one or more users of different email client systems, wherein the disliking decreases the counter. Optionally, again, the liked email is represented in a defined manner in the email client's mail item inbox.

According to still another embodiment an email client system is disclosed, for enabling email communications, implementable on a computing device comprising: one or more processors; and memory storing one or more programs to be executed by the one or more processors; the one or more programs comprising instructions for: enabling the email client system to like at least one email, wherein the liking of the email on the email client system increases like counter of a sender of the email who is working on a second email client system. Optionally, the counter is associated with the sender and represents number of times emails of the sender working on second email client system are liked.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary architecture of email communication between email clients.

FIG. 2 illustrates an exemplary representation of two email clients/applications in accordance with an embodiment of the present disclosure.

FIG. 3 illustrates functional modules of user and moderator email clients/applications in accordance with an embodiment of the present disclosure.

FIG. 4 illustrates an exemplary email thread schema along with the email portion of an email client in accordance with an embodiment of the present disclosure.

FIGS. 5(a) and 5(b) illustrate another exemplary email thread schema along with the mail item screen of an email client, and other features of the proposed email application in accordance with an embodiment of the present disclosure.

FIG. 6 illustrates exemplary inventive features in email client system in accordance with an embodiment of the present disclosure.

FIG. 7 illustrates an exemplary representation for selecting recipients of a highlight action by a moderator in accordance with an embodiment of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the present disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

Although the present disclosure has been described with the purpose of enabling efficient email communication between two or more email clients/applications, it should be appreciated that the same has been done merely to illustrate the invention in an exemplary manner and any other purpose or function for which the explained structure or configuration can be used, is covered within the scope of the present disclosure.

Systems and methods are disclosed for enabling efficient email communication between email clients in a networking environment. In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

Notably, while embodiments of the present invention may be described using modular programming terminology, the code implementing various embodiments of the present invention are not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM®, ColdFire®, GPU, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

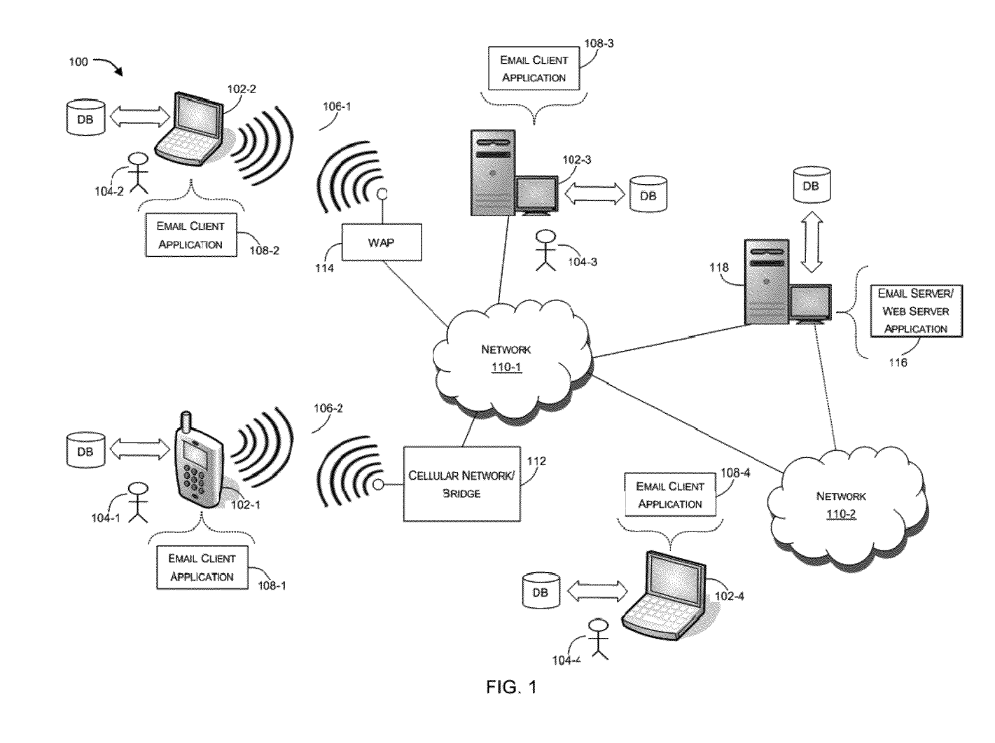

FIG. 1 illustrates an exemplary architecture 100 of email communication between email clients. In one aspect, architecture 100 can include one or more users 104-1, 104-2, 104-3, and 104-4 collectively referred to as user(s) 104 hereinafter, that use one or more computing devices such as 102-1, 102-2, 102-3, and 102-4, collectively referred to as computing device(s) 102 hereinafter, to operate one or more email clients/applications such as 108-1, 108-2, 108-3, and 108-4, collectively referred to as email applications or email clients 108 hereinafter.

In an aspect, architecture 100 can include one or more networks 106-1 and 106-2, collectively referred to as networks 106 hereinafter, that individually or in combination, enable one or more client devices 102 and their respective email applications 108 to communicate/interact with each other. For instance, in an implementation, email client application 108-2 can interact through network 106-1 and then with a core network such as 110-1 through a wireless access point (WAP) 114. Such a core network can be Internet or a Local Area Network (LAN), or any other like network architecture. Similarly, email client application 108-1 can interact through network 106-2 and then with a core network such as 110-1 through a cellular network and/or a bridge 112. On further similar lines, email client application 108-4 can directly interact with core network such as 110-2, which in turn is operatively coupled with network 110-1.

In yet another aspect, architecture 100 of the present can further include a server computing device such as device 118 that can run an email server application 116 and be configured to store emails/backups, enable email communication between client devices 102/client applications 108, along with performing any other desired function. According to one embodiment, server device 118 and/or client device 102 may include, but are not limited to: a personal computer, a server computer, a series of server computers, a mini computer, and a mainframe computer. Server device 118 may be a web server (or a series of servers) running a network operating system, examples of which may include but are not limited to: Microsoft Windows XP Server™; Novell Netware™; or Redhat Linux™, for example. Client device 102 can also be one or a combination of a personal computer, notebook computer, personal digital assistant, tablet PC, or the like. According to another embodiment, email users such as 104 may include an email sender, direct email recipients, and future email recipients.

According to one embodiment, one or more client devices 102 and/or server device 118 can include a storage device such as database coupled to respective client/server device, which may be executed by one or more processors (not shown) and one or more memory architectures (not shown) incorporated into the respective device. Storage device may include but is not limited to: a hard disk drive; a tape drive; an optical drive; a RAID array; a random access memory (RAM); and a read-only memory (ROM).

Server device 118 may execute a web server application, examples of which may include but are not limited to: Microsoft IIS™, Novell Webserver™, or Apache Webserver™, that allows for HTTP (i.e., HyperText Transfer Protocol) access to server computer 118 via the network 110. Network 110 may be connected to one or more secondary networks (e.g., network 106), examples of which may include but are not limited to: a local area network; a wide area network; or an intranet, for example.

As mentioned above, server computer 118 may execute an email server application 116, examples of which may include but are not limited to Lotus Domino™ Server and Microsoft Exchange™ Server. Mail server application 116 may be a mail transfer agent that may store and route email to one or more email client applications 108, examples of which may include but are not limited to Lotus Notes™, Google Mail, and Microsoft Outlook™. Using email client applications 108, respective users 104 may access email server application 116 and may send, retrieve and/or organize email messages.

As illustrated in architecture 100, various client electronic devices may be directly or indirectly coupled to network 110-1 (or network 110-2). For example, personal computer 102-3 is shown directly coupled to network 110-1 via a hardwired network connection. Further, notebook computer 102-4 is shown directly coupled to network 110-2 via a hardwired network connection. Laptop computer 102-2 is shown wirelessly coupled to network 110-1 via wireless communication channel 106-1 established between laptop computer 102-2 and wireless access point (i.e., WAP) 114, which is shown directly coupled to network 110-1. WAP 114 may be, for example, an IEEE 802.11a, 802.11b, 802.11g, Wi-Fi, and/or Bluetooth device that is capable of establishing wireless communication channel between laptop computer 102-2 and WAP 114. Personal digital assistant 102-1 is shown wirelessly coupled to network 110-1 via wireless communication channel 106-2 established between personal digital assistant 102-1 and cellular network/bridge 112, which is shown directly coupled to network 110-1. As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection. Client electronic devices 102 may each execute an operating system, examples of which may include but are not limited to Microsoft Windows™, Microsoft Windows CE™, Redhat Linux™, or a custom operating system.

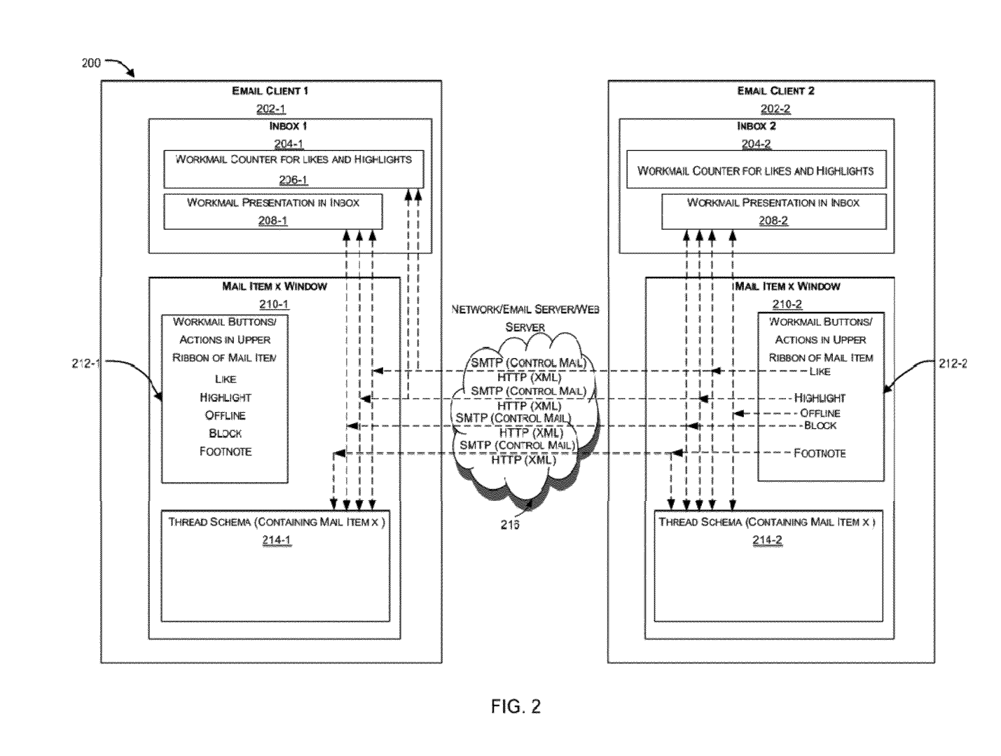

FIG. 2 illustrates an exemplary representation 200 of two email clients/applications 202-1 and 202-2 in accordance with an embodiment of the present disclosure. Representation 200 can include a first email client 202-1 and a second email client 202-2 operatively coupled to each other by means of a network/email server 216, interchangeably referred to as email server 216 hereinafter through protocols such as SMTP. As one would appreciate, system of the present disclosure can include any number of email clients/email applications that are inter-connected with each other by means of one or more networks such as 216, as also shown in FIG. 1. Although a part of the present disclosure is being explained with reference to email client 202-1, one should appreciate that each email client such as 202-2 can have the same/similar/more/less features/applications. Certain email clients can also have different features/applications (or not have features of the present disclosure) and therefore can be different in terms of functionality from other email clients. At the same time, one should also appreciate that different heterogeneous email clients can be incorporated in the present disclosure, wherein application/features of the present disclosure can be configured to be client-independent. Therefore, features installed by the present disclosure in Microsoft Outlook can be compatible with, i.e. can communicate with, features incorporated in Google Mail.

According to one embodiment, email client 202-1 can include an inbox 204-1 showing a list of all emails that user 1 of client 202-1 has received from multiple recipients. Inbox 204-1 can also be interpreted to mean only top navigation bar of the email client/application or any other part of the client as configurable by the present disclosure. In one aspect, inbox 204-1 of email client 202-1 can include a graphical or any other desired form of representation showing one or more counters for “likes” and “highlights”, wherein a like counter can be configured to represent number of likes that have been received by the user of client 202-1 for emails that have been sent by the user. For instance, in case a user A of client 202-1 sends an email to user B of client 202-2 and also to users C and D running clients 202-3 and 202-4, and users B and D like the email sent by user A, the “like counter” for the user A would be incremented by 2. One should appreciate that “like” action is reversible, in the sense that a user can always unlike a previously liked email. Liking can be done by a colleague or any other recipient of the email from the sender based on parameters such as content of the mail, appearance of the email, sender of the mail, previous email exchanges/interactions by the sender of the email, recipients involved in the email, among other like parameters/attributes.

In an implementation, “like” counter for each user of email client such as 202-1 can be visible to colleagues or other defined/configured users, and therefore any such configuration is completely within the scope of the present disclosure. One or more thresholds of likes can also be defined by the present system such that upon reaching a defined number of likes, the user can be promoted or given additional credentials. An email can be liked by any recipient of the email, or can be configured to be liked only by a defined number of recipients/members of the email communication based on say the designation/role/responsibility of the recipient.

In another embodiment, accessing the “like” counter graphical representation, can enable user of an email client 202 to view his/her emails that have been liked, and which email have been liked how many times, and by whom. Any configurational changes in such features are completely within the scope of the present disclosure. Such details, as can be appreciated, can be shown as a dropdown or a popup or as any other representation deemed fit for implementation the proposed system.

In an aspect, “highlight” counter can also be graphically represented on the email client 202-1, wherein the highlight counter represents the number of times different/same emails of the user of the client 202-1 have been highlighted. Such a highlight counter therefore depicts the number highlights that are given to a user based on the emails sent by him/her, which counter can be incremented/decremented based on the highlights given/taken back. In an embodiment of the present disclosure, an email can be highlighted only by users having defined privileges, wherein such users can be referred to as moderators for the sake of simplicity of the present disclosure. One should appreciate that any other nomenclature can be associated with such privileged users. An email can be highlighted by a moderator based on one or more of content of the email, presentation of the email, recipients involved in the email, or any other parameter. In an alternate embodiment, different privileges/rating/ranking/starts can be associated with different users, with user above a defined threshold can be allowed to highlight emails. For instance, a user with a rating of 2/5 can be allowed to highlight only personal emails, whereas a user with a rating of 3/5 can be allowed to highlight official emails with 3 or less recipients, and a user with a rating of 4/5 can be allowed to highlight all incoming emails. Highlighting can also be done in various ways can be configured as desired by different moderators within the scope of the proposed system.

In an instance, in case a user A sends an email to users B, C, D, E, and F, where F is the moderator, user F can highlight the email, which would increase the highlight counter for user A. Such a highlight action can also be viewed by other users in the email chain such as users B, C, and D. In another aspect, such highlight actions are reversible, i.e., a highlighted email can be un-highlighted if desired by the concerned moderator such as user F or by any other moderator having the authority to highlight/un-highlight.

According to one embodiment, upon clicking the highlight option, the moderator can enable highlighted email to be shown in a defined color/format to all recipients of the email. In another implementation, a moderator can also select a defined list of recipients who will receive a special notification next to this email, say a star “*” representation that symbolizes them as special interest recipients for the marked email. For instance, from a list of 10 recipients, the moderate can configure to select 4 recipients that are able to see the email with a star “*” representation. In an implementation, the highlighted email can be seen in a defined color such as in green color, so as to be easily distinguishable from other emails. In such a case, sooner the moderator highlights an email, email clients 202 of all recipients can paint the email with the desired color in their respective inboxes 204 and only the email client of the sender will increment the highlight counter.

In another implementation, a user always can click on the highlight counter representation on his/her inbox 204-1 to view the emails that have been highlighted, moderator involved, recipients in the email, recipients that have been able to view the highlighted representation of the email, among other like parameters/data/content/information.

According to another embodiment, inbox presentation 208-1 can include other graphical representations such as options for offlining emails, blocking emails, incorporating/tagging footnotes, among other like options, which would be described in details hereinafter. One should appreciate that these options/features can although appear together and/or can be presented differently at separate positions in the email inbox 204. Such changes are completely within the scope of the present disclosure. Furthermore, these features can either be incorporated together at the same time in the inbox or can be incorporated selectively depending on the user configuration and preference. For instance, the user may only like to view the like counter along with being able to block emails (through block option) or offline emails (through offline option) but may not want to be presented with highlight counter, and can therefore configure the inbox 204 accordingly.

According to another embodiment, client 202-1 can further include a mail item window 210-1 for showing a particular email such as Mail Item X in the current embodiment. Mail item window 210-1 can also be interpreted as a list of emails in the inbox 204-1, from which one email can be selected and then opened (by double click or any other means) as part of the window 210-1. As seen, mail item window 210-1 can include one or more buttons/graphical representations 212-1 for options including, but not limited to, like, highlight, offline, block, and footnote, which can be incorporated for one or more emails in the inbox 204-1. Therefore, in an exemplary implementation, when a user open an email from the inbox 204-1, he/she is able to view one or more of the above mentioned options 212-1 and take action on the email based on the same, which may also indirectly or directly impact the functioning of the other email clients such as 202-2 or inbox emails therein.

In an embodiment, an email item can include graphical representations for one or more features/options including, but not limited to, like, highlight, offline, block, and footnote. Such features can, in an implementation, be displayed along with other mail menu options in typical email clients such as Microsoft Outlook, wherein the upper navigation bar comprises options such as remove, reply, reply all, forward, move, categorize, translate, zoom, among other like options. In an aspect, like feature can allow user of an email client such as 202-1 to like the current email that is open in the item window. In case of an email thread having a number of emails (replies to one or more preceding emails), any email of the thread can be liked based on say the content of the mail, aesthetic appeal/presentation of the email, sender of the mail, among other like attributes.

In another aspect, highlight feature can allow a selected few email clients, also referred to in the instant disclosure as moderators, to highlight a current email that is open in the item window and then later reverse the highlight if desired. Any of the above mentioned actions such as liking or highlighting can color the respective email with a defined representation so that it becomes easy for a user/recipient to understand the importance/priority of the email and how users interacted/behaved with the same. For instance, an email that is liked can be marked with a green color, and an email that is highlighted can be marked with a blue color. In another instance, with the growing number of likes/highlights or other like allied actions, color of the email can keep changing. For instance, for the first 10 likes, the color can be light green, and the color can keep getting darker with more likes. However, this is only an exemplary implementation, and any other change in representation of the email such as change in font/size/style of subject/email content can also be incorporated and is completely within the scope of the instant disclosure.

another aspect, highlight feature can allow user of an email client such as 202-1 to highlight the current email that is open in the item window. In an embodiment, only a defined number of users, referred to instant disclosure as moderators, can be allowed to highlight an email. However, in another embodiment, any user/recipient of an email can highlight an email, and then later reverse the highlight if desired. Any of the above mentioned actions such as liking or highlighting can color the respective email with a defined representation so that it becomes easy for a user/recipient to understand the importance/priority of the email and how users interacted/behaved with the same. For instance, an email that is liked can be marked with a green color, and an email that is highlighted can be marked with a blue color. In another instance, with the growing number of likes/highlights or other like allied actions, color of the email can keep changing. For instance, for the first 10 likes, the color can be light green, and the color can keep getting darker with more likes. However, this is only an exemplary implementation, and any other change in representation of the email such as change in font/size/style of subject/email content can also be incorporated and is completely within the scope of the instant disclosure.

In another aspect, offline feature can allow user of an email client such as 202-1 to offline the current email that is open in the item window. Such offlining action can be configured to transfer the offline email and all subsequent emails in the same thread/branch to be transferred to a separate offline folder. Such action, like other actions can be reversible, and therefore offlined emails can be put back into the main inbox if desired at a later stage. In an implementation, once an email is offline, any further subsequent incoming email in reply to the offlined email can be moved to the predefined offline directory/folder. In another implementation, even the senders of such further subsequent incoming emails can be offlined so that all their further communications can be moved directly to the offline folder.

In yet another aspect, block feature can enable user of an email client such as 202-1 to block an email (independent email or of a thread). Blocking of an email can disable the blocked email so that no reply (to one or more recipients) can be made to a blocked email. A blocked email, in an implementation, can also be unblocked at any time or for a defined amount of time. Such a blocked email can, in another implementation, also be copied to a separate email folder/directly, referred to as “blocked folder” hereinafter. In another implementation, rights for blocking of an email can only be given to a defined number of users, say only to moderators or to users having a defined number of points/recommendations/highlights/likes/rating/ranking, among any other parameter that be incorporated to categorize users based on their email communications, designation, role, responsibility, promptness, participation, among other like factors. In yet another embodiment, a blocked email can also be represented in a different color/font/size/format either in the inbox or as the mail item or in the thread schema as described below. In an implementation, a blocked email can also be represented differently in the email clients of the recipients of that email, such that, for instance, in a recipient makes an attempt to “reply to all” to a blocked email in the mail item screen, the same would result in a message/pop-up being presented to him/her indicating that the email was blocked by, say a moderator and that a “reply to all” action is not possible.

In yet another aspect, footnote feature of the present disclosure can enable exchange of footnotes between on or more users of email clients/applications 202. In an exemplary implementation, footnote feature can be represented in any desired graphical presentation, such as, for instance, as a button, which when clicked, can enable a user to view a window or text entering interface, in which text that is desired to be sent as footnote can be entered as saved. In an embodiment, such an email is an already received and/or sent email with respect to the user of the current email client, and tagging with a footnote can help in one or more of summarizing the email, adding notes/reminders, or any other content relating, directly or indirectly to the email. In an implementation, along with entering the text for footnote, the user can also select a list of recipients who the user wishes to be able to view the footnote. User can further configure whether the footnote is to be tagged one time, or for all emails, or for a selected set of emails based on one or more parameters. In an exemplary implementation, footnotes can also include links, such as to other emails in an email thread, which can be directly opened by the recipients and then viewed/forwarded/replied to/commented to/among other like actions. Incorporation of a footnote can also be viewed in the thread schema as would be described below so as to allow users to view emails that have one or more footnotes.

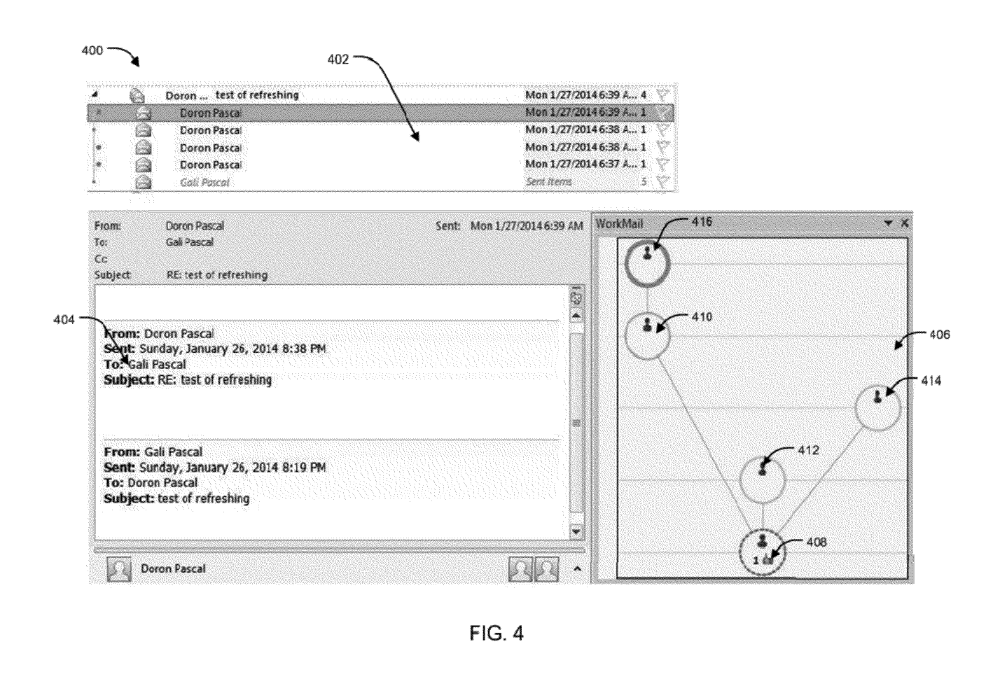

According to one embodiment, mail item 210-1 can further include an email thread schema such as 214-1 for one or more email threads, wherein the email thread schema can represent each email thread having one or more emails in a hierarchical tree presentation, wherein the tree presentation includes a representation of each email of the thread as a node such that one or more emails of the thread are connected with each other through an edge based on their chronological sequence of responses. For instance, the lowest node (root note) can represent the first email, first tier nodes (second last from bottom) can represent replies to the first email, second tier nodes can represent further replies to respective replies presented in first tier nodes, and so on. In an implementation, the hierarchical tree presentation can further include one or more branches that are configured to represent the sequence of responses to one or more emails of the email thread. In an instance, for an email sent by user A to B and C, a reply can be made by B to A and C, wherein in case C then chooses to reply to the first email of A directly, a different branch can be formed when compared with the branch formed if C chooses to reply to the reply of B. Each email of the email thread, being represented as a node, can also be colored to depict whether that email has been highlighted/liked/blocked/offlined/or in case any other action has taken place on the email. Such thread schema would be further described in detail with reference to FIG. 4.

In another aspect of the present disclosure, email clients 202-1 and 202-2 can be configured to exchange metadata information with each other without user intervention, wherein such metadata can be shared either implicitly in a manner such that the shared information is not visible to the user or can be shared as an email such that even the sending user as well as the recipient user(s) can view the metadata content/information. In an instance, such metadata can be shared over the network 216 through control emails/mails as shown in FIG. 2. Such control emails can either be directly shared between email client and/or can be routed/processed through a web server. In case of a web server, for instance, XML can be sent over HTTP via the web server. Therefore, the control mail/control message can either be sent as SMTP via the email server, or can be as XML over HTTP via the web server, or any other known combination in the art. In an embodiment, such metadata can be shared based on one or more actions done by the user on one or more emails or settings related thereto. For instance, in case a user offlines an email, such an action can be learnt automatically by the email client 202 of the user and then shared with a second email client of a second user, whose second email client can then also automatically offline the email without user intervention. Such actions can, not only be triggered based on user actions, but also automatically initiated to enhance communication between email clients and users thereof. Metadata information can also be treated as control messages, which can be shared/exchanged between email clients as emails. In an implementation, such control emails can be configured to be transparent to users. Apart from user interaction, for instance, a moderator's email client can automatically share a highlight update with all or a set of recipients sooner an email is highlighted by the moderator. Similarly, updates on offlining of an email, blocking of an email, adding footnotes to one or more emails, liking of an email can be implicitly sent by the activity initiating email client so that other configured/intended/desired email clients can receive the update and incorporate the same.

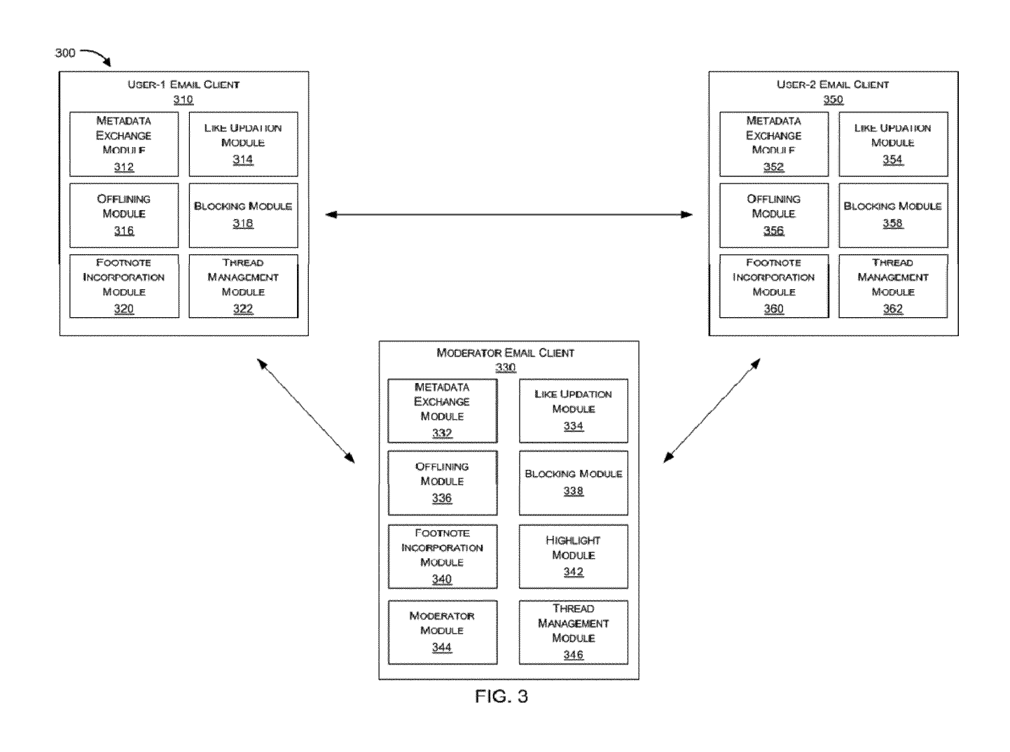

FIG. 3 illustrates functional modules 300 of user and moderator email clients/applications in accordance with an embodiment of the present disclosure. One should appreciate that although all the user email clients such as 310 and 350 have been illustrated to have common functional modules, any email client can always be configured with more or less number of modules depending on user preference, application feature implementation, selection options, among other like parameters. For instance, email client 350 can be configured without the thread management module 362 resulting in an email client that does not represent the tree based hierarchical representation of the email threads. Similarly, although the highlight module 342 has been shown only with respect to moderator email client 330, highlight feature can be made available to all user email clients or can be partially made available based on the user rank/rating/preference/like/ among other like attributes. Similarly, in another implementation, highlight module 342 can be displayed for all email clients, and can be deactivated/disabled for users/email client that do not have the capability/rights/privileges to execute highlight function. Therefore, any such change in construction/configuration/implementation of the features of the present disclosure is completely within the scope of the instant disclosure. One should further appreciate that although the modules are being explained one with respect to any user email client, the same or a partial functionality of the module can be implemented in corresponding modules of other email clients as well. For instance, although metadata exchange module 312 would be explained with reference to user email client 310, the same/similar/partly similar function can be construed/interpreted to be applicable for other emails clients such as 330 and 350 as well.

According to one embodiment of the present disclosure, metadata exchange module 312/352/332 can be configured to enable exchange of metadata information, interchangeably also referred to as data/content/information hereinafter, between two or more email clients. Such metadata information, per se, can be triggered automatically without explicit user intervention/action and can be shared either in the form of an email or as any other implicit message/mail, which may or may not be visible to the user depending on the configuration of the module 312.

In one implementation, metadata information can be shared based on one or more user actions such as liking of an email by a user, highlighting of an email by a user, blocking of an email, offlining of an email, incorporating footnotes in an email, changes in thread schema of an email thread at one email client, among other like actions. Although such actions may be a result of a user action, the metadata information can be shared inherently and automatically without any need of a explicit trigger from the user. In an implementation, in case a user changes priority of an email by shuffling the emails present in the inbox, such changes in the email priority can be learnt by the email client, based on which the module 312 can be enabled to capture the change in priority and/or the reasons behind the same, and incorporate such changes in emails of other email clients as well. However, one should appreciate that such implementation is only exemplary, and the module 312 can be configured to control the kind of metadata information that is shared and the level of impact it can have on the email clients of other users. Similarly, sooner an email is liked by a first user, email client of the first user can capture the like action, and enable the same to be incorporated in the corresponding email of all email clients that are in receipt of the email.

In another aspect of the present disclosure, metadata exchange module 312 therefore can be configured to exchange metadata information with each other without user intervention, wherein such metadata can be shared either implicitly in a manner such that the shared information is not visible to the user or can be shared as an email such that even the sending user as well as the recipient user(s) can view the metadata content/information. In an instance, such metadata can be shared over a network through control SMTP emails/mails. In an embodiment, such metadata can be shared based on one or more actions done by the user on one or more emails or settings related thereto. For instance, in case a user offlines an email, such an action can be learnt automatically by the email client 202 of the user and then shared with a second email client of a second user, whose second email client can then also automatically offline the email without user intervention. Such actions can, not only be triggered based on user actions, but also automatically initiated to enhance communication between email clients and users thereof. Metadata information can also be treated as control messages, which can be shared/exchanged between email clients as emails. In an implementation, such control emails can be configured to be transparent to users. Apart from user interaction, for instance, a moderator's email client can automatically share a highlight update with all or a set of recipients sooner an email is email is highlighted by the moderator. Similarly, updates on blocking of an email, liking of an email, among other like actions can be implicitly sent by the activity initiating email client so that other configured/intended/desired email clients can receive the update and incorporate the same.

In another aspect, like updation module 314/354/334 can be configured to enable a user to like an email, wherein such a like action on an email can enable everyone or a defined set of users in the email chain to be able to view the liked representation. Such a like action can be taken by a user based on any parameter such as content of the email, presentation of the email, sender of the email, among other like factors. A like counter can be associated with each email so as to enable any or a partial set of recipients of the email to view the number of users who have liked the email. In an instance, the number of users to be able to view the like can be defined by the original sender of the email, or by the moderator, or by any other user configured by the present system. In an implementation, a liked email can always be unliked, which would result in decrement in the counter. In another implementation, priority of a liked email, depending on the number of likes, can also be changed, such that, for instance, the mail is presented in a different color or is put higher up in the order of email or is sent to the “important” email client folder/directory. Any such change in the configuration for liked emails are completely within the scope of the present disclosure.

In another aspect, like updation module 314/354/334 can be configured to enable a user to like another user of an email client, who is also the sender of an email. For instance, in case a user X sends an email to users Y and Z, both or any of the users Y and Z can, along with or without liking the email per se, also like the user X for the email being sent. Therefore a separate counter can be configured/established in the email client of a user that denotes the number of times that user has been liked for emails that have been sent by him. In an implementation, a user may not necessarily send an email to be liked and can also be liked for his overall suggestions/recommendations/among other attributes/parameters. Liking action of an email can also be configured to change the color of the email item and/or of the email item node being represented in the thread schema, as would be explained below. In yet another embodiment, clicking the like counter can also enable the user to view the details of likes such as number of likes, users who have liked, emails of the user that have been liked, among other such details.

In an embodiment, although module 314 has been explained with respect to both “user like counter” as well as “email like counter”, one should appreciate that both these features can be implemented seperately through independent modules, wherein a first module can be configured to enable users to like an email to increase the email like counter for that email, or can like multiple emails sent by a user to increase the like counter for the sender user. In another implementation, module 314 can also be configured as two sub-modules or in any other configuration, all of which are within the scope of the present disclosure.

In another aspect, offlining module 316/356/336 can be configured to allow user of an email client such as to offline the current email that is open in the mail item window. Any other email that is not currently open but accessible can also be marked offline, wherein such offlining action can be configured to transfer the offline email and/or all subsequent emails in the same thread/branch to be transferred to a separate offline folder. In an exemplary implementation, offlining an email also enables the user not to receive any notification when a reply to the offilined email is received as such emails can directly be moved/transferred to the offlined folder. Such action, like other actions can be reversible, and therefore offlined emails can be put back into the main inbox if desired at a later stage. In an implementation, once an email is offlined, any further subsequent incoming email in reply to the offlined email can be moved to the predefined offline directory/folder. In another implementation, even the senders of such further subsequent incoming emails can be offlined so that all their further communications can be moved directly to the offline folder.

In an implementation, offlining action can be configured to only affect the user doing the action without impacting behavior of the same email towards other user that are part of the email chain/thread. An offlined email can also be represented in a different manner, say through a different color in the email thread schema as would be explained subsequently. In yet another implementation, any incoming email replying to an offlined email or to its followers can be moved to the offlined directory or any other predefined directory under the main inbox directory. Followers in such a case can include users who, based on an offlining action taken by a user, also offline (automatically or manually) the email and therefore follow the actions of the first user.

In yet another aspect, blocking module 318/358/338 can be configured to enable a user of an email client to block an email (independent email or of a thread). Blocking of an email can disable the blocked email so that no reply (to one or more recipients) can be made to a blocked email. A blocked email, in an implementation, can also be unblocked at any time or for a defined amount of time. For instance, once blocked, the email can only be unblocked for say 20 hours, post which the blocking becomes permanent. Such a blocked email can, in another implementation, also be copied to a separate email folder/directly, referred to as “blocked folder” hereinafter. In another implementation, rights for blocking of an email can only be given to a defined number of users, say only to moderators or to users having a defined number of points/recommendations/highlights/likes/rating/ranking, among any other parameter that be incorporated to categorize users based on their email communications, designation, role, responsibility, promptness, participation, among other like factors. Therefore, in an instance, blocking module 318/358 can disabled from regular user email clients 310 and 350 and can only be enabled for the moderator email client 330. In yet another embodiment, a blocked email can also be represented in a different color/font/size/format either in the inbox or as the mail item or in the thread schema as described below. In an implementation, a blocked email can also be represented differently in the email clients of the recipients of that email, such that, for instance, in a recipient makes an attempt to “reply to all” to a blocked email in the mail item screen, the same would result in a message/pop-up being presented to him/her indicating that the email was blocked by, say a moderator and that a “reply to all” action is not possible.

In yet another aspect, footnote incorporation module 320/360/340 can be configured to enable exchange of footnotes between on or more users of email clients/applications. In an exemplary implementation, footnote feature can be represented in any desired graphical presentation, such as, for instance, as a button, which when clicked, can enable a user to view a window or text entering interface, in which text that is desired to be sent as footnote can be entered as saved along with the email. In an implementation, such an email is an already sent/received email and tagging a footnote to a sent/received information can help, for instance, in summarizing the email, its content, objective, related emails, among other desired purposes. One or more recipients of a tagged email can automatically view the footnote based on the configuration/settings of the footnote feature. In an implementation, along with entering the text for footnote, the user can also select a list of recipients who the user wishes to be able to view the footnote. User can further configure whether the footnote is to be tagged one time, or for all emails, or for a selected set of emails based on one or more parameters. In an exemplary implementation, footnotes can also include links, which can be directly opened by the recipients and then viewed/forwarded/replied to/commented to/among other like actions. Incorporation of a footnote can also be viewed in the thread schema as would be described below so as to allow users to view emails that have one or more footnotes.

In another aspect, highlight module 342, although presented only for the moderator email client 330, can also be incorporated/enabled for each user email client depending on the configuration of the proposed system. In an embodiment, highlight module 342 can be configured to enable, say a moderator, to highlight an email of a user/sender, wherein the action of highlight increases the “highlight” counter for the sender of the email. Therefore, the number of highlights of a user can depict the number of emails that have been sent by the user and which have been highlighted by one or more authorized users such as moderators. In an embodiment of the present disclosure, an email can be highlighted only by users having defined privileges/rights, wherein such users can be referred to as moderators for the sake of simplicity of the present disclosure. One should appreciate that any other nomenclature can be associated with such privileged users. An email can be highlighted by a moderator based on one or more of content of the email, presentation of the email, recipients involved in the email, or any other parameter. In an alternate embodiment, different privileges/rating/ranking/stars can be associated with different users, with user above a defined threshold can be allowed to highlight emails. For instance, a user with a rating of 2/5 can be allowed to highlight only personal emails, whereas a user with a rating of 3/5 can be allowed to highlight official emails with 3 or less recipients, and a user with a rating of 4/5 can be allowed to highlight all incoming emails. Highlighting can also be done in various ways and can be configured as desired by different moderators within the scope of the proposed system.

In an instance, in case a user A sends an email to users B, C, D, E, and F, where F is the moderator, user F can highlight the email, which would increase the highlight counter for user A. Such a highlight action can also be viewed by other users in the email chain such as users B, C, and D. In another aspect, such highlight actions are reversible, i.e., a highlighted email can be un-highlighted if desired by the concerned moderator such as user F or by any other moderator having the authority to highlight/un-highlight.

According to one embodiment, upon clicking the highlight option, the highlight module 342 can present the moderator a defined list of recipients that he/she would like the module to send additional “special interest” notification. For instance, from a list of 10 recipients, the highlight module can attach an additional star (*) such that only 4 recipients are able to see the email with the star (*) representation. In an implementation, the highlighted email can be seen in a defined color such as in green color, so as to be easily distinguishable from other emails. In such a case, sooner the moderator highlights an email, email clients of selected recipients can paint the email with the desired color in their respective inboxes and thread schema along with incrementing the highlight counter for the sender of the email. The selected few recipients who were chosen as “special interest” ones, will also see a star in their inbox next to that email in Inbox or thread schema.

In another implementation, a user always can click on the highlight counter representation on his/her inbox to view the emails that have been highlighted, moderator involved, recipients in the email, recipients that have been able to view the highlighted representation of the email, among other like parameters/data/content/information.

In an aspect, moderator module 344 can be configured to enable any other function to be performed by the moderator for which the moderator is authorized. As mentioned above, moderator can be defined based on certain rights/privileges that are accorded to him/her based on previous history, role, responsibility, number of user highlights, number of user likes, among other like parameters. In an implementation, moderators can also be of various types/categories/levels/tier, such as, for instance, a tier-1 moderator can be given only certain rights to control the email client behavior of other users, whereas tier-2 moderator may be given additional rights/controls, and so on. Any number of such tiers with varying rights can therefore be defined in accordance with an embodiment of the present disclosure.

In an aspect of the present disclosure, thread management module 322/346/362 can be configured to present an email thread schema for one or more email threads, wherein the email thread schema can represent each email thread having one or more emails in a hierarchical tree presentation, wherein the tree presentation includes a representation of each email of the thread as a node such that one or more emails of the thread are connected with each other through an edge based on their chronological sequence of responses. An exemplary email thread schema can be explained with reference to FIG. 4, which illustrates user's inbox 402, mail item 404 in which one of the emails from “Doron Pascal” to “Gali Pascal” is open, and a thread schema 406, which represents all emails in the email thread having subject “test of refreshing”. In an illustration, the lowest node (root note) 408 can represent the first email, whereas the first tier nodes (second last from bottom) 410/412/414 represent three different replies to the first email itself, and second tier nodes such as 416 can represent further reply to the first reply represented by node 410. Each of these three first tier nodes 410/412/414 therefore can represent three different branches, replied to which can then be made, wherein each reply can, depending on the email to which it is done, can be represented accordingly in the thread schema 406.

In an implementation, the hierarchical tree presentation, also referred to as thread schema in the present disclosure, can further include one or more branches that are configured to represent the sequence of responses to one or more emails of the email thread. In an instance, as also mentioned above, for an email sent by user A to B and C, a reply can be made by B to A and C, wherein in case C then chooses to reply to the first email of A directly, a different branch can be formed when compared with the branch formed if C chooses to reply to the reply of B. Each email of the email thread, being represented as a node, can also be colored to depict whether that email has been highlighted/liked/blocked/offlined/footnote/or in case any other action has taken place on the email. For instance, a bold circle shown for node 416 can denote that the node is current open/visible to the user. Sooner the user chooses another email from the thread, the corresponding node can be highlighted. One should appreciate that such coloring/lining are only exemplary representations and any other such graphical representation is completely within the scope of the present disclosure. For instance, node 408, which represents the first email can be colored in say blue color. In another instance, an email highlighted by a moderator can be colored in green circle.

In an exemplary embodiment, node 516 shows a star (*) representation, which can be configured to represent a highlighted email that has special interest to the user of the email client. Such an email can also be represented through a green colored node, wherein the color green can represent a set of highlighted emails. Similarly, nodes 510 and 516 also represent a “thumbs up” representation, indicating that these emails have been liked, wherein a like counter can also be represented along with the like indication. As shown, both the emails 516 and 510 show the like counter of 1, meaning that only one user, as of now, has liked the emails. In an embodiment, a liked email can also be represented in a different color as may be desired by the proposed system. One should appreciate that color selection/type of circle, type/color/depth/length of node/edge are completely matters of design and any such change in configuration/construction is completely within the scope of the present disclosure.

In another exemplary embodiment, node 518 represents an offlined email, which can, for instance, be represented as a grey colored node. As this email 518 has been offlined by the user, all subsequent emails of this email such as shown by node 520 can automatically be marked offline. On similar lines, node 514 shows a footnote 524 being associated along with the email 514, wherein text/links can be added in the footnote 524 and one or more recipients of the email can see the footnote. In an implementation, as mentioned above, emails having footnotes can also be depicted/represented in a different color.

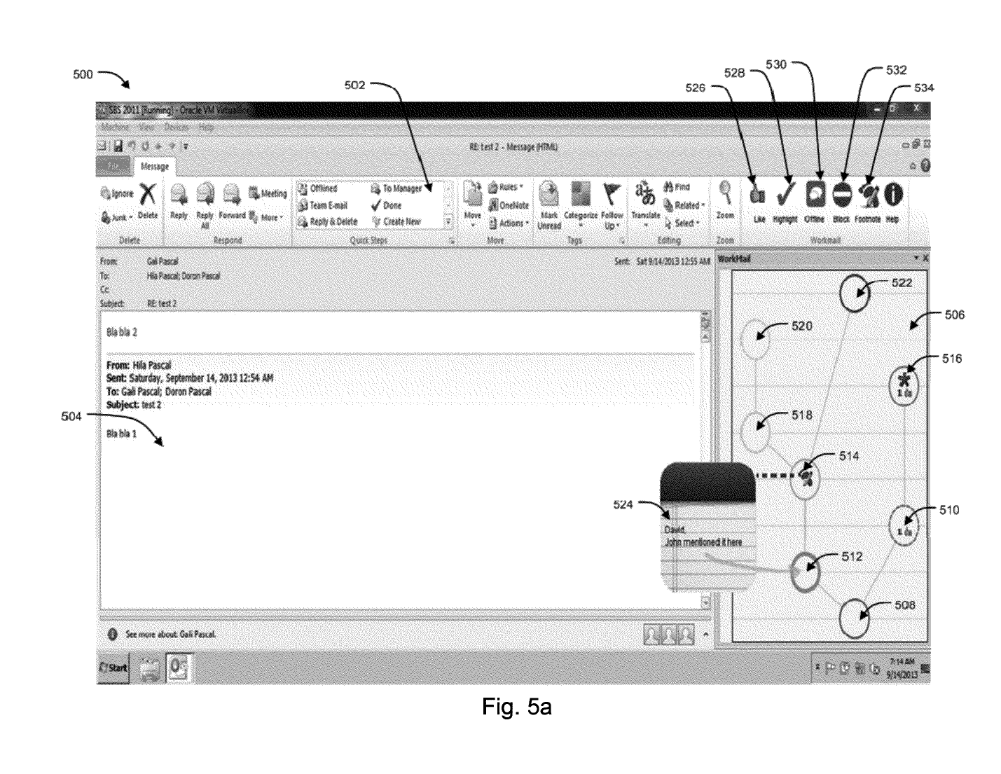

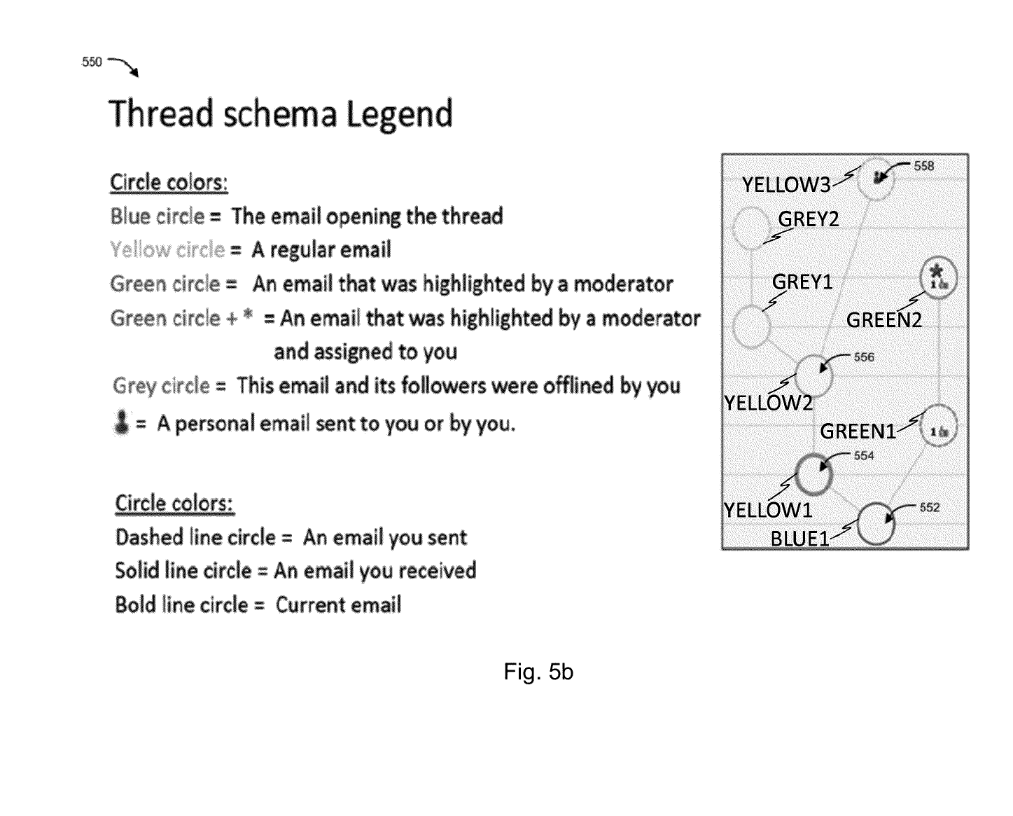

FIG. 5(b) shows an exemplary color representation definition 550 for various nodes, wherein, for example, blue color can be used for representing the first email BLUE1 that opens the email thread, yellow color represents a regular email (which has not been offlined/liked/highlighted/blocked) YELLOW1, YELLOW2, YELLOW3, green color represents a highlighted email GREEN1, “green color circle+*” represents an email GREEN2 that was highlighted and assigned to the user viewing the thread schema, grey color represents and offlined email GREY1, GREY2. Along with the nodes, even the edges joining the nodes can be colored or represented as dashed line, solid line, bold line or any other representation. In another instance, a dashed line node can represent an email sent by the user using the current email client, solid line node can represent an email received by the user viewing the current email client, and bold line node can represent the currently open email item. As mentioned above, even the edges connecting the nodes can be represented in different formats/colors/sizes/shapes to depict a different meaning. One should appreciate that although present disclosure has been explained with reference to only a few set of colors/lines, any other color/format can be incorporated to depict any desired meaning. For instance, a “person icon” can be used to depict a personal email being sent solely to the user using the current email client or sent by the user viewing the email client to a sole recipient. For instance, node 558 can represent a personal email being sent by the user running the current email client. Such an email 558 can be in reply to the email/node 556 but instead of doing a “reply to all” action, a reply was made personally to the user viewing the inbox. Furthermore, as mentioned above, node 552 represents the first email in the thread, and node 554 (in bold) represents the currently open email.

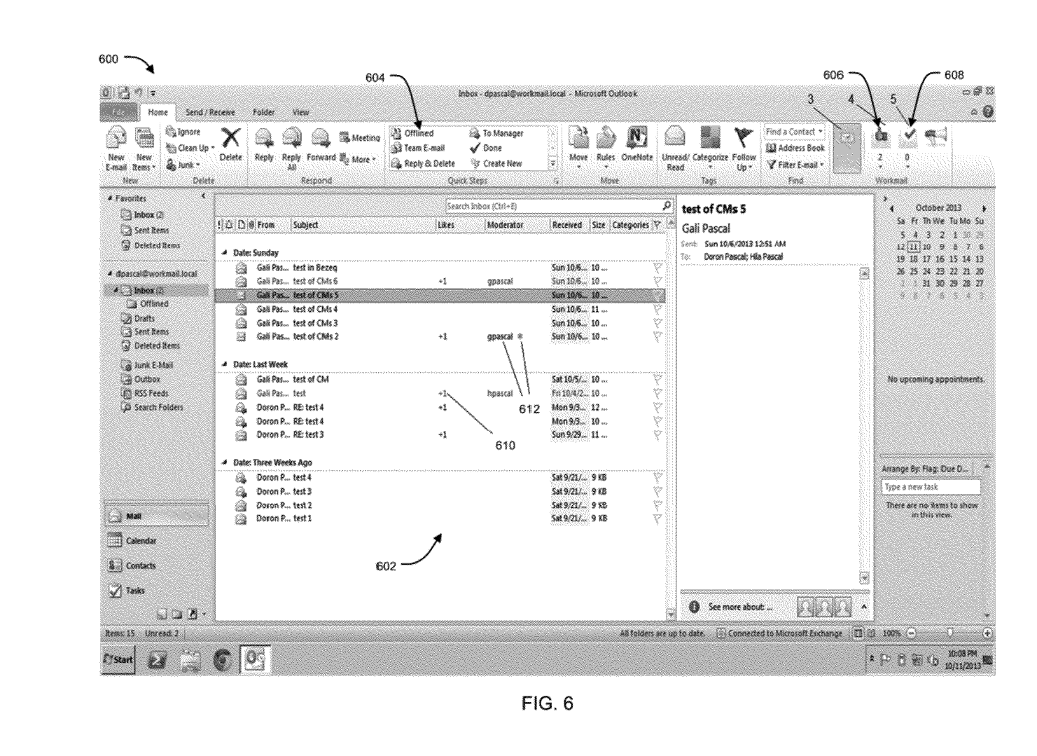

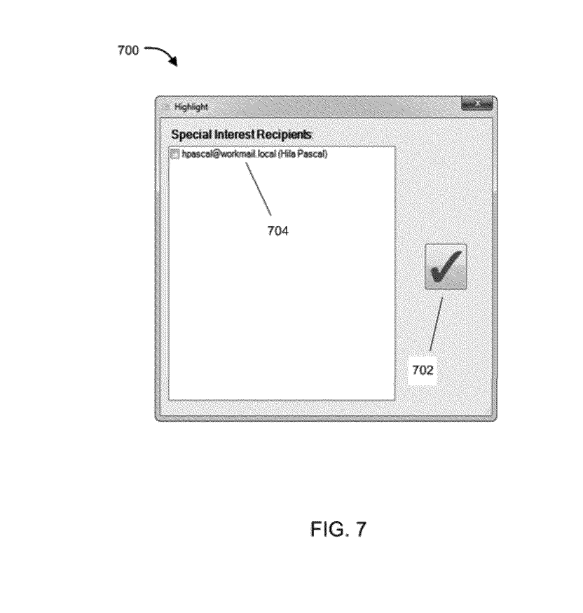

Coming back to FIG. 5(a), the representation 500 further shows options menu 502 having an exemplary widget showing a like icon 526, highlight icon 528, offline icon 530, block icon 532, footnote icon 534, functions of all of which have already been explained in detail above. In an implementation, user of the email client 500 can click on the like icon 526 to increase the like counter for the email shown in mail item 504. Similarly, the user can also highlight/block/offline the email based on the rights/priviliges that the user possesses. In another implementation, user of the email client 500 can also add a footnote 524 to an already sent/received email node 514. Such a footnote 524 can also include a link, for instance, to email thread 512 as shown. In an implementation, clicking on the highlight icon 528 can open up a window such as window 700 shown in FIG. 7, wherein the user can click on button 702 to enable all recipient to receive the highlighted representation in their corresponding email, and can also view the changed color (green in the present illustration) of the node in the thread schema 506. This highlighted representation will also be shown in all other users thread schema. Green coloring of email as well as name of moderator highlighting the email will also be shown in inbox, item 612 of all recepients. Such an action can also increase the overall highlight counter for the sender of the email, wherein such a counter can be seen by clicking on icon 608 of FIG. 6, which would be explained below. In an alternate embodiment, user of client 500 can also click on item 704 to select a defined/desired number of intended recipients, post which when the user selects 702, the star (*) representation can be sent only to the selected intended recipients. Use of the option 704 can therefore be configured to add a star (*) mark in the node representing this email in the thread schema of the checked/selected/desired/intended recipients. Such a star (*) mark can be used for depicting users that have been designated as special interest recipients using option 704. This star (*) will also appear in the inbox item 612 of all recepients.

FIG. 6 illustrates another exemplary email client representation 600 of email client inbox showing a plurality of emails in the inbox screen 602 along with having an options menu 604 showing the like counter 606 and highlight counter 608 for the user operating/working/configured on the email client 600. Clicking on the icons 606/608 can enable the user of the client 600 to view the emails on which the likes have been granted to the user, other users who have liked the email, timestamp of likes, among other similar details. Similar details are also available for the highlight counter 608 in accordance with an embodiment of the present disclosure. Representation 610 shows the number of likes/dislikes that each email has received, wherein, in an instance, +1 indicates one like, and −1 indicates one dislike on the respective email. In another implementation, representation 612 shows the moderator involved in highlighting the email, or in general who the moderator is for that email/thread.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An email client system, for enabling email communications, implementable on a computing device comprising:
one or more processors; and
memory storing one or more programs to be executed by the one or more processors; the one or more programs comprising instructions for:
operatively communicating with a second email client system, wherein said second email client system is configured as a moderator; and
enabling one or more automatic actions to be performed directly on emails of said email client system by said second email client system, wherein said email client system and said second email client system have at least one email exchanged between them.

2. The email client system of claim 1, wherein said one or more automatic actions are selected from a group comprising highlighting said at least one email, deleting said at least one email, recommending said at least one email, blocking said at least one email, liking said at least one email, and marking at least one email in a defined manner.

3. The email client system of claim 1, wherein said moderator is pre-assigned, and wherein said at least email, in said email client system, shows said assigned moderator.

4. The email client system of claim 1, wherein said second email client system becomes the moderator based on one or a combination of current role, responsibility, past actions, previous email history, number of likes from other email client systems, number of recommendations from other email client systems.

5. The email client system of claim 1, wherein performance of said one or more automatic actions changes appearance of said at least one email, wherein said change in appearance is selected from one or a combination of change in color of said email, change in priority of said email, and change in order of said email.

6. The email client system of claim 1, wherein said one or more automatic actions are performed on all email client systems that are part of said at least one email.

7. The email client system of claim 1, wherein said one or more automatic actions are performed on all email client systems that are related to said at least one email.

8. An email client system, for enabling email communications, implementable on a computing device comprising:
one or more processors; and
memory storing one or more programs to be executed by the one or more processors; the one or more programs comprising instructions for:
representing an email thread comprising at least one email in form of a hierarchical tree presentation, said hierarchical tree presentation comprising representation of each email of said at least one email as a node, wherein each node is operatively coupled with another node through an edge.

9. The email client system of claim 8, wherein said hierarchical tree presentation comprises one or more branches, wherein said one or more branches are configured to represent the sequence of responses to one or more emails of said email thread.

10. The email client system of claim 8, wherein said hierarchical tree presentation comprises one or more branches, wherein said one or more branches are configured to represent threads of serial email communications in chronological order.

11. The email client system of claim 8, wherein a first set of nodes are indicated by a first color, said first set of nodes being indicative of a regular email.

12. The email client system of claim 8, wherein first email of said email thread is represented by a second color.

13. The email client system of claim 8, wherein a second set of nodes are indicated by a third color, said second set of nodes being indicative of highlighted emails, wherein said highlighted emails are highlighted by one or a combination of a moderator running a second email client system, user of said email client system, or user of a third email client system.

14. The email client system of claim 8, wherein a third set of nodes are indicated by a fourth color, said third set of nodes being indicative of a personal email sent only to user of said email client system.

15. The email client system of claim 8, wherein a fourth set of nodes are indicated by a fifth color, said fourth set of nodes being indicative of one or more emails or their followers/senders being offlined by user of said email client system, wherein offlined emails are not shown as a regular email in said email thread, and wherein said offline action is reversible.

16. The email client system of claim 8, wherein a fifth set of nodes are indicated by a sixth color, said fifth set of nodes being indicative of liked emails, wherein said liked emails are liked/marked by one or a combination of a moderator running a second email client system, user of said email client system, or user of a third email client system.

17. The email client system of claim 8, wherein a sixth set of nodes are indicated by a seventh color, said sixth set of nodes being indicative of highlighted emails that are assigned to user of said email client system, wherein said highlighted and assigned emails are highlighted and assigned by one or a combination of a moderator running a second email client system, or user of a third email client system.

18. The email client system of claim 8, wherein each of said nodes is represented as one of a solid line or a dashed line based on whether said node represents an email that was sent or received by user of said email client system.

19. The email client system of claim 8, wherein at least one node is represented to indicate currently open email.

20. The email client system of claim 19, wherein said at least one node is represented as a bold line.

21. The email client system of claim 8, wherein said hierarchical tree presentation is shown in email item interface of said email client system.

22. An email client system, for enabling email communications, implementable on a computing device comprising:
one or more processors; and
memory storing one or more programs to be executed by the one or more processors; the one or more programs comprising instructions for:
enabling said email client system to send metadata directly to a second email client system without intervention of users of said email client system or said second email client system.

23. The email client system of claim 22, wherein said metadata comprises information extracted from one or more user actions taken on emails of said email client system, emails liked by user of said email client system, emails highlighted by user of said email client system, priority of emails of said email client system, actions taken by moderator of a third email client system on said email client system, emails blocked by user of said email client system, emails offlined by user of said email client system, emails replied to by user of said email client system, and any other action taken by user of said email client system.

24. The email client system of claim 22, wherein said metadata received by said second email client system enables automatic updation of said second email client system, said updation selected from one or a combination of deletion of one or more emails, prioritization of said one or more emails, tagging of said one or more emails, marking of said one or more emails, liking of said one or more emails, highlighting of said one or more emails, blocking of said one or more emails, offlining of said one or more emails, and an action taken automatically on said second email client system.
